(19) United States
(12) Patent Application Publication
(10) Pub. No.: US 2017/0236227 A1
(43) Pub. Date: Aug. 17, 2017

(54) FINANCIAL BENCHMARK AND REPORT GENERATOR AND SOFTWARE DISTRIBUTION METHODS AND SYSTEMS

(71) Applicant: Steven B. Wagner, San Clemente, CA (US)

(72) Inventor: Steven B. Wagner, San Clemente, CA (US)

(21) Appl. No.: 15/276,675

(22) Filed: Sep. 26, 2016

Related U.S. Application Data
(63) Continuation of application No. 13/692,848, filed on Dec. 3, 2012, now abandoned.
Application No. 13/692,848 is a division of application No. 11/612,372, filed on Dec. 18, 2006, now abandoned.

(51) Int. Cl. G06Q 50/22; G06Q 10/06; G06Q 40/00

(52) U.S. Cl. CPC G06Q 50/22; G06Q 40/12; G06Q 10/067

(57) ABSTRACT

A financial simulation tool for use in adjusting operations of a business. In some embodiments the financial simulation tool uses information regarding a total amount of business and a percentage of business in each of two business segments comprising the business to generate simulated financial statements. The simulated financial statements may be used for benchmark comparisons, for example with respect to actual business results. In one embodiment the financial simulation tool is configured for financial simulation of an independent eyecare professional business, and the financial simulation tool provides profit and loss statements based on a total number of patients and a percentage of patients enrolled in a managed care or third party payer program.

### BACKGROUND

The invention relates generally to financial simulation models, and more particularly to business financial simulation models using limited input variables.

Financial simulations of a business are useful in evaluating past operations of the business, considering future changes in operation of the business, and monitoring effects of those changes over time. Benchmark comparisons of actual results, using for example publicly available information regarding a competitor or industry averages to obtain the simulated results, allows for evaluation of past operations with respect to others in the industry. Benchmark comparisons with other businesses in the same industry also provide insight into industry best practices. Execution of financial simulations with data reflecting potential changes to operations allows for consideration of how those changes may affect the financial performance of the business.

Information concerning many types of businesses is publicly available. For example, many businesses are subject to public reporting requirements, and provide extensive information to the public regarding their operations. Other businesses may not provide such information, but often trade journals and the like publish survey results detailing industry wide information. Moreover, in some industries, lenders or various consultants may take it upon themselves to survey their clients and make available, on an average basis for example, the information obtained in order to more fully assist and engage their client base.

Generating financial simulations may be complex even with information available regarding results of others within an industry. Effects of changing a particular business practice generally impacts numerous revenue and/or cost components on a profit and loss statement. Determining the financial relationships and the laborious recalculation of interrelated financial components may be viewed as requiring excessive effort or beyond the expertise of the business owner. In any event the simulation process may be viewed as requiring excessive effort, and in any event slows the simulation process, possibly to the extent that sufficient simulations may not be executed in any available time.

### SUMMARY OF THE INVENTION

The invention provides a business financial simulation tool using limited user inputs. In some embodiments the financial simulation tool provides an industry benchmark analysis for a business with simulated results for a similarly situated business In some embodiments the invention provides a business financial simulation tool using two user inputs, the two user inputs characteristic of a business in a particular industry. In one embodiment the particular industry is the eye care profession industry, and the two user inputs are indicative of number of patients and percentage of those patients subject to managed care and third party contracts.

In one aspect, the invention provides a method performed using at least one computer system for generating a profit and loss statement for a business using a limited set of input parameters, comprising determining relationships between financial figures portraying portions of operations of a business; determining a limited set of parameters describing operations of the business, at least one of the parameters descriptive of a totality of business operations and at least one of the parameters indicative of a split of business operations into at least two segments; receiving values generated by a user for the limited set of parameters; and determining financial results of operation of the business based on the values for the limited set of parameters and at least some of the relationships between financial figures portraying portions of operations of the business.

In another aspect the invention provides a method performed, using at least one computer system, of evaluating financial effects of changes in business practices of a business, comprising determining relationships between costs and revenues associated with provision of goods and/or services provided by the business and aspects of the business; determining at least some of the aspects of the business that project across the provision of the goods and/or services provided by the business; receiving values indicative of the at least some of the aspects of the business; determining expected financial operations of the business based on the values indicative of the at least some aspects of the business; and comparing the expected financial operations of the business with actual financial operations of the business.

In another aspect the invention provides a method of generating financial statements including a profit and loss statement for a business using only a limited number of parameters representative of total business operations of the business, the limited number of parameters including a parameter indicative of an aspect relating to total volume of the business expressed in units and a parameter indicative of a percentage of business in a defined segment, the method comprising providing a financial simulation tool on a server, the financial simulation tool configured to generate a profit and loss statement for a business based on the limited number of parameters and figures for costs and revenues associated with units of business in the defined segment and figures for costs and revenues associated with units of business outside the defined segment; providing a user interface on a client computer, the user interface configured to receive the limited number of parameters and to display a profit and loss statement; receiving the limited number of parameters by the client computer; transmitting the limited number of parameters by the client computer; receiving the limited number of parameters by the server; generating the profit and loss statement by the server; transmitting information of the profit and loss statement by the server; receiving the information of the profit and loss statement by client computer; and displaying the profit and loss statement on the client computer.

In another aspect the invention provides a method of providing business financial estimation software updates for a financial statement generation tool, comprising storing in memory associated with a server software for generating a profit and loss statement based on a number of units indicative of a total amount of business and a percentage of units in a defined segment and using relationships between figures; storing in memory associated with the server software for use in providing a user interface for receiving from a user the number of units indicative of a total amount of business and the percentage of units in the defined segment; receiving a request from a client computer for use of the software for generating the profit and loss statement; providing the software for use in providing a user interface to the client computer for use through electronic transmission from the server to the client computer of the software for use in providing a user interface; providing the software for generating the profit and loss statement to the client computer for use through electronic transmission from the server to the client computer of the software for generating the profit and loss statement; storing in memory associated with the server updated software for generating the profit and loss statement; receiving a further request from the client computer for use of the software for generating the profit and loss statement; and providing the updated software for generating the profit and loss statement to the client computer for use through electronic transmission from the server to the client computer of the updated software for generating the profit and loss statement.

In another aspect the invention provides a method of providing updated software for use by users using user computers, comprising storing software instructions for execution in memory associated with a server computer coupled to the Internet; updating the stored software instructions for execution from time-to-time to form then current stored software instructions for execution; receiving a request for use of the stored software instructions from a client computer; and providing the then current software instructions for execution to the client computer.

These and other aspects of the invention are more fully comprehended upon review of this disclosure.

### BRIEF DESCRIPTION OF THE DRAWINGS

FIG. 1 is a flow diagram of a process for performing financial simulations using limited user inputs and, optionally, adjusting operations of a business in accordance with aspects of the invention.

FIG. 2 is a flow diagram of a process for determining weightings for business operations related to the limited user inputs in accordance with aspects of the invention.

FIG. 3 is a block diagram of a computer network configured to perform financial simulations in accordance with aspects of the invention.

FIG. 4 is a flow diagram of a process of performing a financial simulation by a stand alone system in accordance with aspects of the invention.

FIG. 5 is a flow diagram of a process of performing a financial simulation by a networked system in accordance with aspects of the invention.

FIG. 6 is a block diagram of a system for performing financial simulations in accordance with aspects of the invention.

FIG. 7 is a flow diagram of a process for providing software updates.

FIG. 8 is a flow diagram of a process for providing user invisible software updates and user simplified financial report generation.

FIG. 9 is a flow diagram of a process of performing a financial simulation in accordance with aspects of the invention.

FIG. 10 is a screen shot of an embodiment of an entry screen of limited user inputs in accordance with aspects of the invention.

FIG. 11 is an example revenue and cost of goods sold spreadsheet in accordance with aspects of the invention.

FIG. 12 is an example gross revenue analysis spreadsheet in accordance with aspects of the invention.

FIG. 13 is an example cost of goods sold spreadsheet in accordance with aspects of the invention.

FIG. 14 is an example gross margin spreadsheet in accordance with aspects of the invention.

FIG. 15 is an example operating expenses spreadsheet in accordance with aspects of the invention.

FIG. 16 is an example profit and loss statement in accordance with aspects of the invention.

### DETAILED DESCRIPTION

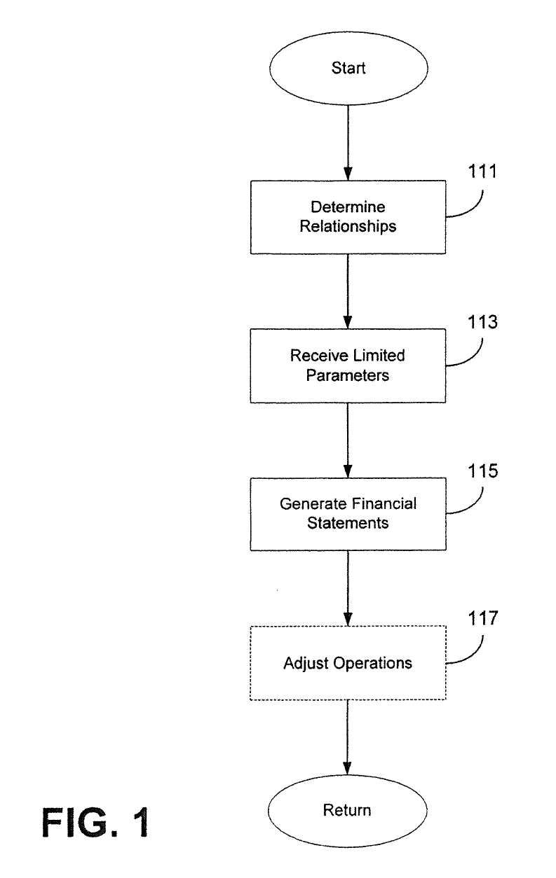

FIG. 1 is a process in accordance with aspects of the invention. The process is used, in various embodiments, for benchmark comparisons of a business within an industry, for adjustment of business operations, for financial report generation, or for other purposes. In block 111 the process determines relationships between financial figures associated with business operations. In many embodiments the determination of relationships between financial figures determines values associated with revenues and costs for provision of particular goods and/or services, coefficients for modification of the values depending on aspects of the business, and weightings to be applied depending on aspects of the business. In many embodiments the values, coefficients, and weightings pertain to units, which when summed may provide an indication of total business operations, or pertain to a segment of business operations. The values, for example, provide different cost and revenue values for per unit costs and revenues of the business. The coefficients, for example, may modify the values depending on business segment, or may indicate relative size of a business segment to total business operations. The weightings, for example, may provide relative weightings based on business segment for costs related to, for example, gross revenue. In some embodiment some or all of the values, coefficients, or weightings may depend on location, for example of a business or a customer.

In some embodiments the determination of relationships includes a determination of a representation of total business operations, preferably a representation which may be reduced to a numerical term. For example, a total number of chips sold in a year may be a representation of total business operations for some businesses. For other business a total number of customers served per year, or a total number of transactions over a defined time period, or a total number of days open for business, or a total number of customer calls, or some other parameter may be a representation of total business operations. Preferably there is a relationship, which may vary depending on circumstances, between gross revenues and the representation of total business operation. Also preferably there is a relationship between costs and the representation of business operations.

In some embodiments the determination of relationships includes a determination of a segmentation of the representation of total business operations. Preferably the segmentation, which may be a split, partitions the representation of total business operations into different cost and/or revenue schemes. The segmentation may be based on any of a number of factors, for example continent of sale, currency for the transaction, size of customer, weather on sale date, or other factor. For example, for an automobile assembler a number of vehicles sold may be a representation of total business operations, and costs and/or revenues per unit vehicle may be different depending on whether, for example, the vehicle is a car or a truck, or, for example, whether the vehicle is part of a fleet sale or sold to a dealership. Accordingly, it should be understood that in many embodiments the choice of representation of total business and the choice of segments may be considered projective assumptions, assumptions that project across an entire business, or a defined portion of an entire business.

In block 113 the process receives limited parameters regarding the business. The limited parameters are provided, for example, by a user. Preferably the limited parameters are characteristic of a particular business. In most embodiments the limited parameters are the representation of total business and size, generally relative size, of the partitions of the representation of total business. In some embodiments the limited parameters provide information regarding gross units and a split of those gross units into different cost and/or revenue schemes. For example, for a semiconductor business the parameters may represent a total number of chips sold and, assuming chips are either sold in lower gross margin product lines or higher margin product lines, a percentage of chips sold in either the lower gross margin product lines or the higher gross margin product lines. As an alternative example, the parameters may represent chip sets sold, and whether the chip sets are custom chip sets or standard chip sets. As another example, in some service industries some clients may represent higher margin clients, whether due to those clients being willing to pay additional fees for similar services, requiring a mix of services in aggregate with higher margins, or for other reasons. As a more detailed example, in the eyecare professional industry private patients, as opposed to managed care patients such as those receiving care and service under the rubric of a master contract of a health maintenance organization, tend to be higher margin clients. Accordingly, the parameters may represent total number of patients and the percentage of those patients covered by a master contact.

In block 115 the process generates financial statements. The financial statements generally include a profit and loss statement. The process generates the financial statements using the values, coefficients and weights previously determined, and the received limited parameters.

In block 117 the process optionally adjusts operations of a business. For example, the generated financial statement may indicate that reduced reliance on managed care clients, even to the extent of a lower total number of clients, would improve profitability of the business. The business may therefore be adjusted by a refusal to take on additional managed care clients. As another example, the generated financial statements may indicate that future financial goals may be met by increasing sales of lower margin units. The business may therefore be adjusted by attempts to increase sales of lower margin units.

In some embodiments the process in block 117 optionally receives the results of an actual business for benchmark comparison with the generated financial statements. In some embodiments the process compares the generated financial statements with the results of the actual business, and displays the results of the comparison and/or stores the results of the comparison in memory for later retrieval.

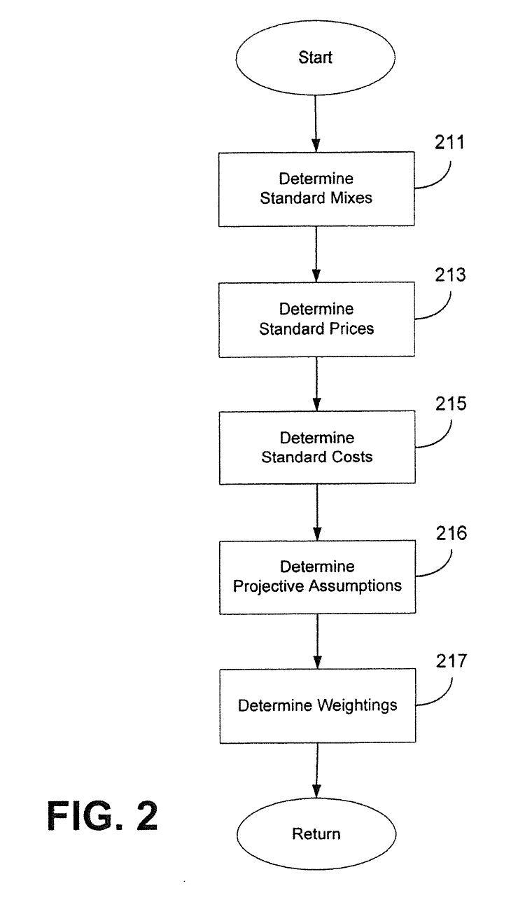

FIG. 2 is a process for determining coefficients and values associated with a business, and particularly coefficients and values as they relate to the business and limited parameters for adjustment of a financial simulation. The process of FIG. 2 may be used, in some embodiments, to perform operations of block 111 of the process of FIG. 1. In block 211 the process determines standard mixes of products and/or clients for a business. In block 213 the process determines standard prices for products and/or services. In block 215 the process determines standard costs for products and/or services. In block 216 the process determines projective assumptions, for example a representation of total business operations and segments of the representation of business operations. In various alternative embodiments, the operation of block 216 occurs before, or amidst, the operations of the other blocks. However, often the operations of the other blocks provides insight as to the selection of the representation of total business operations and the definition of segments thereof. In block 217 the process determines weightings between the split in business operations represented by one of the limited parameters. The weightings are determined for each of the products and/or services.

In many embodiments the process of FIG. 2 is performed by an individual or a group of people, and may be performed by undertaking an analysis of results of operations of multiple business entities, or through a review of information made publicly available through press releases, regulatory filings, or available literature.

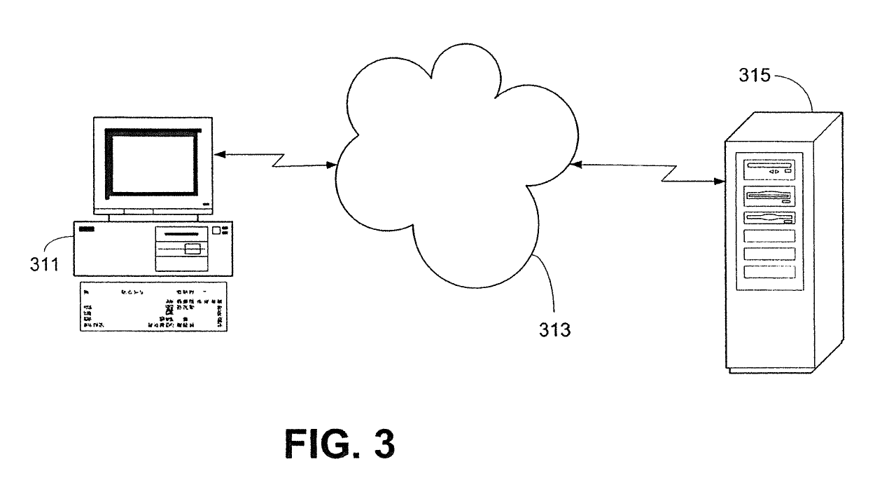

FIG. 3 is a block diagram of a system for performing processes in accordance with aspects of the invention. The system includes a computer 311. The computer may be in various embodiments a personal computer, a SPARC station, or other computer unit. The computer includes at least one processor, memory associated with the processor, a bulk memory device such as a hard drive, and associated input devices such as keyboard and mouse, and associated output devices such as a monitor. In some embodiments the computer operates in a stand-alone fashion, with data and executable instructions stored in the bulk memory device and loaded from time to time into the memory associated with the processor, with the processor executing the executable instruction and operating on the data and user inputs to generate outputs, which are displayed on the monitor and/or stored in the bulk memory device. In some embodiments the executable instructions include a spreadsheet calculator type program, such as Excel by Microsoft Corporation, and formulas defined for various cells of one or more spreadsheets. Generally, in the stand-alone configuration, the executable instructions and data stored in the bulk memory, and acted upon by the processor, are as described with respect to the other figures.

In many embodiments, and as illustrated in FIG. 3, the computer is coupled to a network. Accordingly, the computer includes a network interface such as a network interface card, wireless communication device, or other network communication device. Preferably, the computer also includes a browser-type program, such as a web browser, for processing data received over the network and for providing data to other computers or computer systems over the network.

The network is generally the Internet 313. The network is, in various alternative embodiments, a computer network, such as a local area network (LAN), wide area network (WAN), or a conventional telephone system (POTS). In various embodiments the network may include network devices such as routers, switches or repeaters, and integrated services digital network (ISDN) lines, digital subscriber lines (DSL), cable lines, and wireless connections such as radio frequency transmissions and satellite transmissions.

Also coupled to the network is a server 315. For convenience only a single server is shown, although it should be recognized that in many embodiments multiple servers may be employed. For example in many embodiments each server of the multiple servers perform a specialized task, for example interfacing with the network, serving as a compute engine for performing calculations associated with processes discussed herein, or for storing executable instructions for performing such calculation. Moreover, in many embodiments multiple servers may each perform the same tasks or sub-tasks, with requests from different clients being propagated to different servers, for example on a round-robin or other load balancing basis.

Each server generally includes a processor and memory associated with the processor, along with a network interface card and other similar components generally included with servers. Further each server generally either has an associated bulk memory device or access to multiple bulk memory devices shared by multiple servers.

In operation, the server receives requests and data from the computer system 311, and acts upon the requests by performing calculations by executing instructions, for example as described with respect to the other figures, and transmits results of the calculations to the computer system 311.

In some embodiments the server receives requests for use of the executable instructions, and the server acts upon the requests by providing copies of the executable instructions to a requesting client computer for execution by the requesting client computer, and the server may receive such request every time a user using a client computer makes a request for a calculation, or every time the user begins a new calculation session. Conveniently the executable instructions may be updated from time-to-time, for example as new or additional information becomes available regarding relationships between figures, or simply revised cost or revenue values. Provision of executable instructions in such a manner allows for updates of the executable instructions without an explicit request for an update of executable instructions, and in many cases in a manner invisible to the user. Moreover, provision of the executable instructions to the user allows the user to perform the calculations without the need for transmission of user input information, particularly the limited parameters, but also the results of the calculations, over possibly insecure third party networks. Thus, in some embodiments the invention provides over a network updated user interactive software, for example calculation software, for use in a non-networked manner.

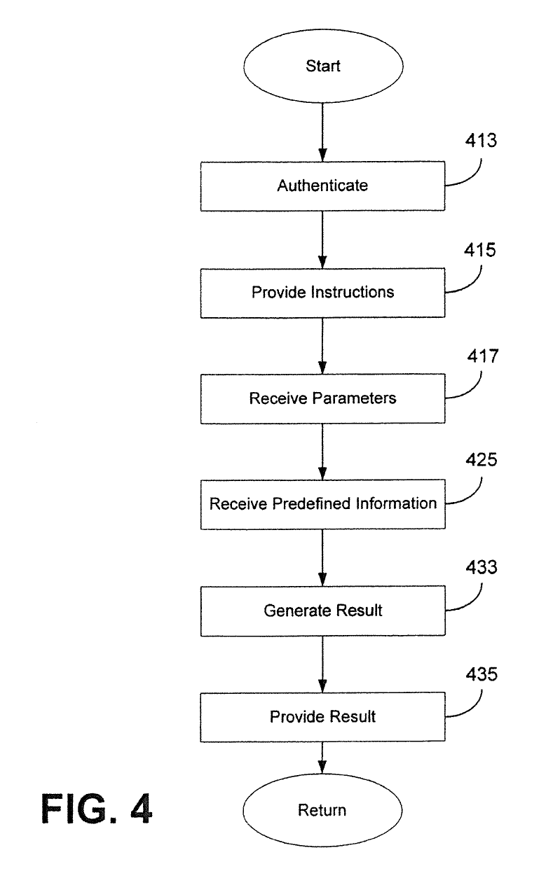

FIG. 4 is a flow diagram of a process used in a business modeling system in accordance with aspects of the invention. The process of FIG. 4 may be used, in some embodiments, to perform the operations of blocks 113 and 115 of the process of FIG. 1. In some embodiments the process of FIG. 4 is performed by a stand alone computer system. In other embodiments portions of the process are performed by a client computer with a browser, and other portions are performed by a server representative to requests and data from the client computer In block 413, the process performs an authentication. In one embodiment, the authentication includes displaying a license agreement and providing an option to accept the agreement. In some embodiments, authentication includes asking for a user identifier and password. In some embodiments, the authentication includes requesting payment information, such as a credit card.

In block 415, the process provides instructions for use of the system. In one embodiment, the instructions are text. In some embodiments, the instructions are a combination of text, audio, and video. In some embodiments, the instructions are presented together with a request for the parameters, such as by explaining what a parameter is and then accepting the parameter as an input.

In block 417, the process receives parameters indicative of a business condition. In some embodiments, receiving the parameters may include receiving a file name or link to a location of the parameters. Generally, however, the parameters are input by a user using a computer. The parameters are values indicative of information about the business. Preferably the values are for a limited subset of values indicative of the business. For example, the parameters may indicate a total number of customers of a business and a percentage of the total number of customers who fall into a particular category. For a medical practice or similar business, for example, the values may indicate a number of patients per year and the percentage of patients covered by an insurance or managed care plan. In one embodiment, the process receives the parameters by way of a software application, such as a spreadsheet. For example, the parameters are entered in designated cells of the spreadsheet. A cell may be designated by way of a label or a description in an accompanying cell.

In block 425, the process receives predefined information. In some embodiments, receiving the predefined information includes receiving a file name or link to a location of the predefined information. In some embodiments, receiving the predefined information includes sending a query to a remote location, such as a server. In some embodiments, receiving the predefined information includes parsing a set of data.

In most embodiments the predefined information comprises information of prices for products and services, on a per product and service and per category basis. In addition, in most embodiments the predefined information comprises information of direct and indirect costs related to the products and services, again on a per product and service and per category basis.

In block 433, the process generates a result. In many embodiments, generating a result includes processing the parameters indicative of a business condition together with the predefined information. In some embodiments, for example, generating a result includes performing calculations defined by the predefined information, using the parameters as inputs to the calculations. In some embodiments, generating the result includes generating a graphical representation of the solutions to the calculations.

In block 435, the process provides the result. In some embodiments, the process provides the result by displaying it. In some embodiments, the process provides the result to another process. In some embodiments, the process provides the result to a server for further processing. In some embodiments, the process provides the result together with a description of the results. In some embodiments, the process provides the results by displaying graphical results together with numerical results.

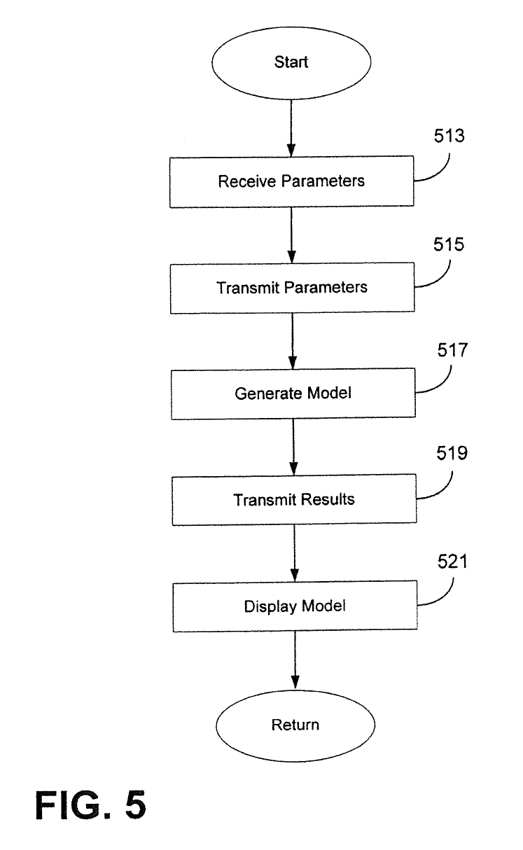

FIG. 5 is a flow diagram of a business modeling process in accordance with aspects of the invention. The process of FIG. 5 may be used, in some embodiments, to perform the operations of blocks 113 and 115 of the process of FIG. 1. In block 513 the process receives parameters indicative of a business condition.

In some embodiments, the process receives the parameters from a database. In some embodiments, the process receives the parameters from a computer program, such as an accounting program. In some embodiments, the process receives the parameters by way of a web application, such as a form submission on a web-page. In some embodiments, the web-page looks like a spreadsheet. In some embodiments, the process receives at least one updated parameter.

In block 515, the process transmits the parameters. In one embodiment, the process transmits the parameters to a server having a computation engine. For example, the process transmits the parameters to a computation engine that is part of a spreadsheet application. In some embodiments, such as where the process receives parameters into a computation engine, the process may not transmit the parameters.

In block 517, the process generates a model. In one embodiment, the process generates the model by combining the parameters with the predefined information. Combining the parameters with the predefined information generally may include determining if the predefined information includes formulas, determining if the parameters satisfy inputs to the formulas, and satisfying the inputs to the formulas using the parameters and predefined information, thereby performing the calculation described by the formula.

For example, in one embodiment, a spreadsheet is utilized. The predefined information is received by the process, such as by loading a file containing the information. The process performs a series of calculations in accordance with the formulas in the predefined information. The process uses the parameters as inputs to the formulas. The results of the calculations are stored, such as on a new spreadsheet.

In one embodiment, a web-based system is utilized. The predefined information is received by the process, such as by loading a file containing the information. The process performs a series of calculations in accordance with the formulas in the predefined information. The process uses the parameters as inputs to the formulas. The results of the calculations are stored.

In some embodiments, the predefined information may be received from a database. In some embodiments, the predefined information may be received from a third party. In some embodiments, the predefined information is hidden to prevent duplication. In some embodiments, the predefined information includes metadata or a link to data, such as a pointer to the current price of a barrel of oil. In some embodiments, the predefined information is selected from a list of predefined information, the list of predefined information corresponding to different sets of business conditions.

In some embodiments, the process generates a model corresponding to the results of processing the parameters in accordance with the formulas from the predefined information. The results may be numbers, graphs, charts, text, or a combination thereof. In some embodiments, generating the model includes generating a graphical representation of the results. In some embodiments, generating the model includes prompting the user for additional information. In some embodiments, generating the model includes generating a plurality of models, each representative of a set of parameters or predefined information. In some embodiments, generating the model includes executing a macro or computational engine process.

In block 519 the process transmits the results from block 517. For example, in one embodiment, transmitting the results includes communicating the results to the client computer. In some embodiments, transmitting the results includes communicating a graphical representation of the results generated in block 517. In some embodiments, transmitting the results includes transmitting wirelessly, transmitting to another process, sending an e-mail, transmitting to a printer, notifying the user, storing the results in a database, communicating the results to a server, or transmitting to a third party. In some embodiments, transmitting the results includes communicating the predefined information and the parameters.

In block 521 the process displays the model. In one embodiment, displaying the model includes showing the results on a spreadsheet. For example, displaying the model includes displaying the numerical portion of the results and the graphical portion of the results.

In one embodiment, displaying the model includes displaying on a television, a projector, a CRT, or an LCD. In some embodiments, displaying the model includes displaying a subset of the results. In some embodiments, displaying the model allows portions of the results to be selected, such as by a mouse click. In some embodiments, multiple models may be displayed simultaneously. In some embodiments, models may be compared with previously saved models. In some embodiments, models may be compared with models provided by a third party.

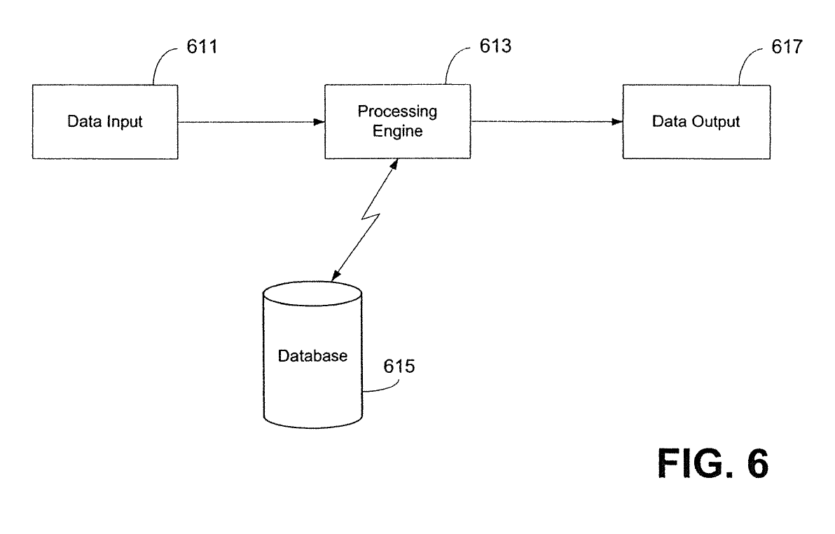

FIG. 6 is a block diagram of a system used, for example, in a modeling system in accordance with aspects of the invention. The blocks of the system of FIG. 6 are generally implemented as software programs for execution using a processor.

Data input block 611 accepts input data. For example, the data input block accepts input data indicative of a business condition. In some embodiments, the input data includes numerical data about a business.

A processing engine 613 receives the input data from block 611 and predefined information, for example from a predefined information database 615. The processing engine generally may include a set of rules for determining if the input data and predefined information can be combined to generate output data. In some embodiments, the processing engine parses the predefined information to determine inputs, and compares the inputs to those from the input data. The processing engine generally performs a calculation using the set of rules, input data, and predefined information.

The processing provides output data to a data output block 617. Generally, the output data is a result of the processing engine.

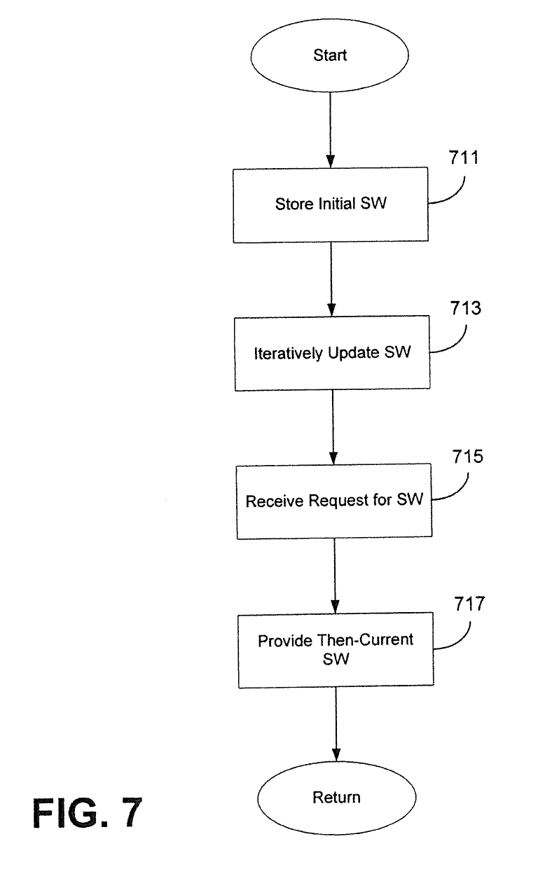

FIG. 7 is a flow diagram of a process for providing updates of software. For example, the process of FIG. 7 is used in some embodiments for providing updated executable instructions, such as discussed with respect to FIG. 3. In many embodiments the software performs operations, for example, of blocks 113 and 115 of the process of FIG. 1, of blocks 425, 433, 435 of the process of FIG. 4, or of block 517 of FIG. 5.

In block 711 the process stores a version of the software. Generally the version of the software is stored in memory of or accessible to a server. In block 713 the process iteratively updates the software. Updating of the software may occur from time-to-time, for example to improve internal operation of the software, to improve results provided by the software, to configure the software to execute on different platforms, hardware or software, or to provide new, additional, or changed functionality to the software.

In block 715 the process receives a request for the software. A request is received, in some embodiments, upon each occurrence of a request for use of the software, upon each occurrence of a request for execution of the software, or for each session of use by a user of the software. Generally the request is received over a network, usually the Internet. In block 717 the process provides the software. The software provided is usually a then-current version of the software. In most embodiments the software is provided by transmission of the software from the server to a client computer system, over for example a network or the Internet. In addition, it should be noted that in most embodiments the operations of blocks 713 and, in combination blocks 715 and 716, may be repeated various times and in various orders.

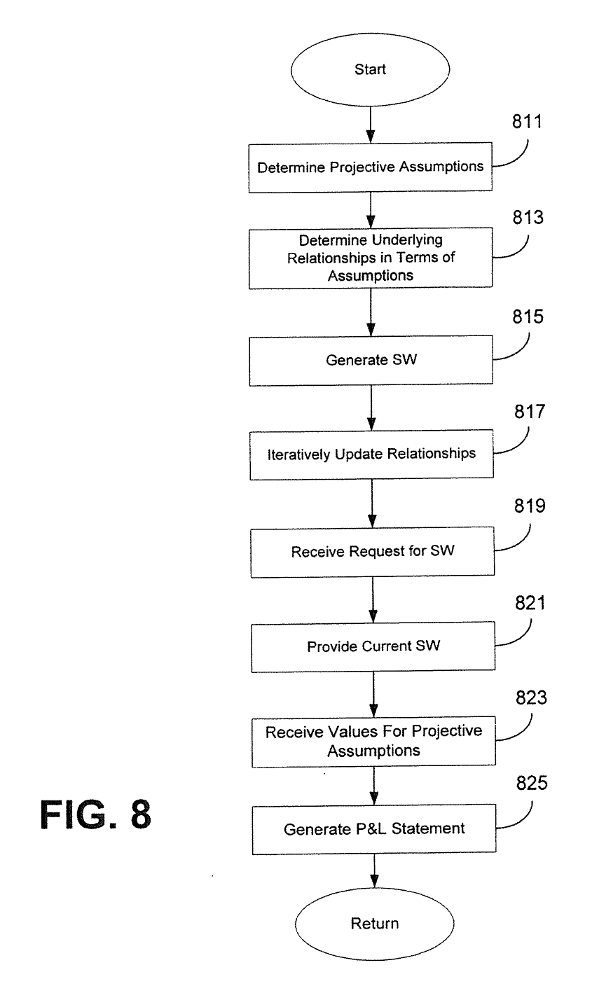

FIG. 8 is a flow diagram of a further process in accordance with aspects of the invention. In many embodiments the process of FIG. 8 provides a financial report generator for use by a user, with ease of updating of the financial report generator, ease of generation of financial reports, with increased security for user supplied and user related data.

In block 811 the process determines projective assumptions regarding a business or a portion of a business. Preferably the projective assumptions include a parameter indicative of total business operations and a parameter indicative of a segment, or partition, of total business operations. Preferably the parameter indicative of total business operations is expressible as a numerical value, for example a value indicative of a total number of units, with the units being units sold in some embodiments, but the units being a count of some entity or condition in many embodiments. Preferably the parameter indicative of the segment is a percentage of units of the total number of units ascribed to the segment of the total business operations.

In block 813 the process determines underlying relations between figures used or useful in generating financial statements for the business. Preferably the underlying relations are specific to a particular segment, or provide a relationship between segments for figures representing similar or the same information across segments.

In block 815 the process generates software, or executable instructions, for generating a profit and loss statement based on values for the parameters and the underlying relations. In block 817 the process iteratively updates the software, generally by updating the relations between figures used or useful in generating the financial statements, for example due to receipt of additional or new information.

In block 819 the process receives a request for the software. In most embodiments the request is received over a computer network, and in many embodiments the request is received over the Internet. In block 821 the process provides the software, generally over the network and generally to a client computer system.

In block 823 the process receives values for the parameters. In many instances the parameters are parameters provided by a user for a specific business, and in many cases may be values from actual business operations. In block 825 the process generates a profit and loss statement based on the parameters, generally by execution by the client computer system of the provided software.

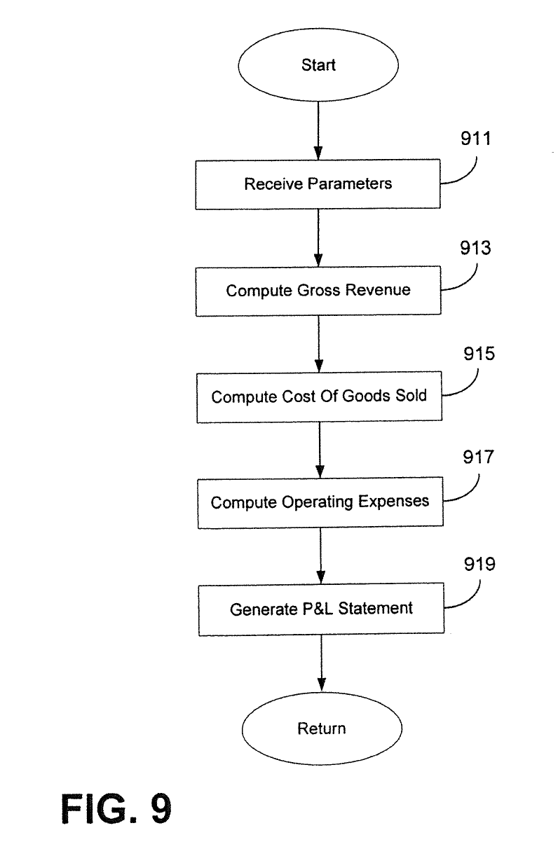

FIG. 9 is a flow diagram of a process in accordance with aspects of the invention. In general, the process may be viewed as receiving a parameter indicative of a total amount of business and a parameter indicative of a division of the total amount of business into two portions, and generating a business profit and loss statement based on the two parameters. In some embodiments the process is performed by a stand-alone computer. In some other embodiments the process is performed by a server, receiving information over a network and providing results to a client computer.

In block 911 the process receives parameters indicative of information regarding a business. In most embodiments the parameters are a parameter indicative of a total amount of business and a parameter indicative of a division of the business into two segments.

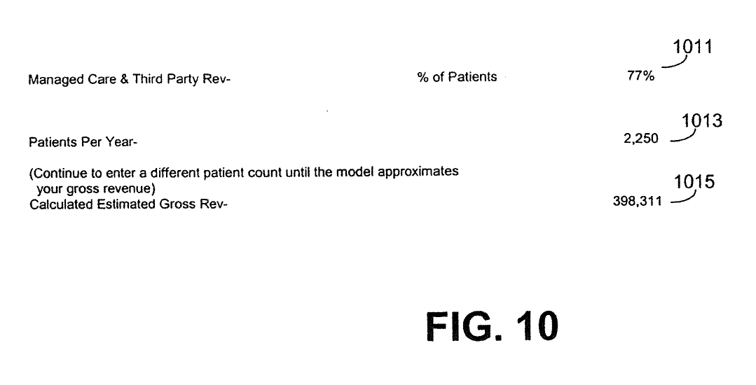

FIG. 10 illustrates an input screen displaying a parameter indicative of a total amount of business and a parameter indicative of a division of the business into two segments, for an independent eyecare professional. The screen of FIG. 10 includes an entry 1013 for a number of patients per year, which may be considered indicative of a total amount business for the independent eyecare professional. The screen of FIG. 10 also includes an entry 1011 for a percentage of the patients covered by a managed care plan (with patients either covered by a managed care plan or private patients), which may be considered indicative of a division of the business into two segments.

Returning to FIG. 9, in block 913 the process computes gross revenue for the business. In some embodiments, the computed gross revenue is displayed on the screen of FIG. 10 as a calculated value 1015.

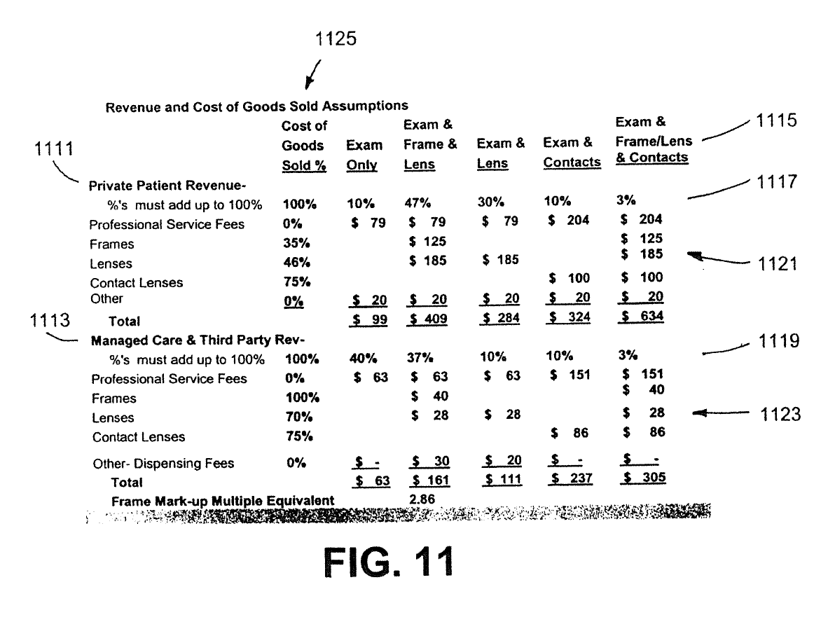

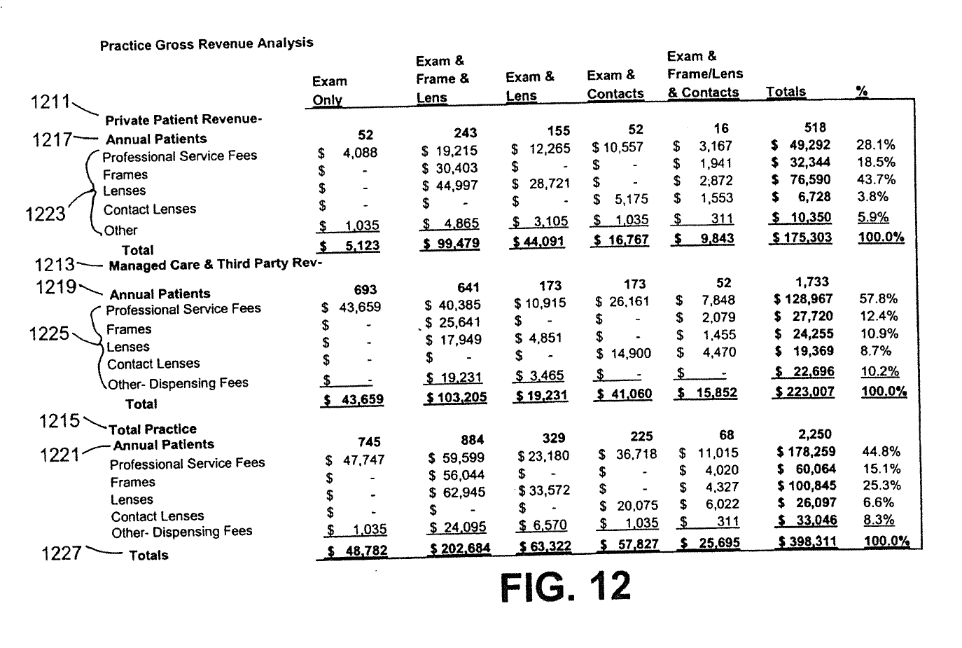

FIGS. 11 and 12 provide additional information regarding the calculation of gross revenue. FIG. 11 shows revenue assumptions, with the revenue assumptions on a per patient basis, for both private patients 1111 and managed care patients 1113. The revenue assumptions are also on a per category basis 1115, for example some patients receive a service in the form of an examination, while others receive an examination and a good or combination of goods as well. In the example of FIG. 11 the goods are eyeglass frames, eyeglass lenses, and contact lenses.

Assumed revenues per patient and per category are indicated in FIG. 11, with private patient assumed revenues 1121 and managed care patient assumed revenues 1123 provided. The assumed revenues may be determined, for example, by considering material published in trade journals and the like, or by surveying a sample of independent eyecare professional practitioners.

Also provided in FIG. 11 is a percentage breakdown of patients per category for patients in each segment, and a percentage cost of goods sold for each of the assumed revenues. Again, the percentage breakdown of patients per category for patients in each segment and the percentage cost of goods sold for each of the assumed revenues may be found by examining publicly available literature or by conducting a survey of the relevant businesses.

FIG. 12 shows a spreadsheet illustrating gross revenue calculations. The gross revenue calculations take into account the assumptions illustrated in FIG. 11 and the parameters indicative of a total amount of business, number of patients in this case, and the percentage of business in each of two segments, private patients and managed care patients in the illustrated example. Calculations are made for both private patient revenue 1211 and managed care patient revenue 1213. These calculations are combined to provide total practice revenues 1215.

The number of private patients 1217 for each category of combination of goods and services is based on the total number of private patients multiplied by the respective percentages for each category, pertaining to private patients, from the information of FIG. 11. Similarly, the number of managed care patients for each category of combination of goods and services is based on the total number of managed care patients multiplied by the respective percentages for each category, pertaining to managed care patients, also from the information of FIG. 11. Based on the number of patients and the revenues per category, for each category revenues are calculated for private patients 1223 and revenues are calculated for managed care patients 1225. Combining the revenues for private patients and managed care patients provides total gross revenues 1227. As previously indicated, total gross revenue is also provided on the screen shown in FIG. 10.

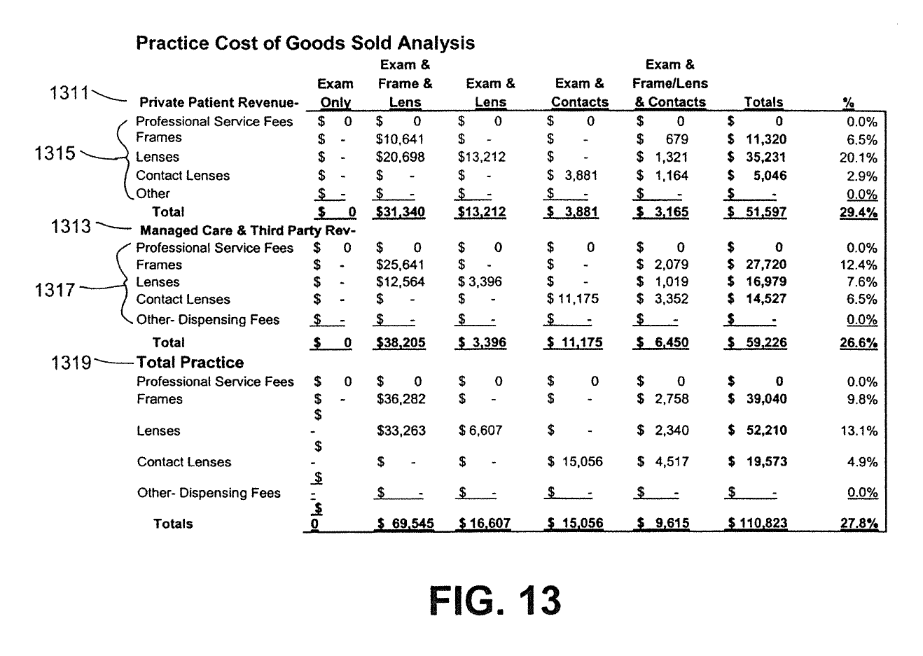

Returning again to FIG. 9, in block 915 the process computes cost of goods sold. In one embodiment cost of goods sold are calculated on a per category and a per segment basis, making use of gross revenues per category and per segment. Accordingly, FIG. 13 shows the results of calculations for the example of the independent eyecare professional business. Private patient cost of goods 1311 and managed care cost of goods 1313 are separately calculated. The cost of goods for private patients for each service or good 1315 are determined on a per category basis, as are the cost of goods for managed care patients for each service or good 1317. The calculations are performed by multiplying previously calculated total revenues for each category, service or good, and patient segment by the previously determined corresponding assumed cost of goods percentage. The totals for each are summed to provide a total cost of goods 1319.

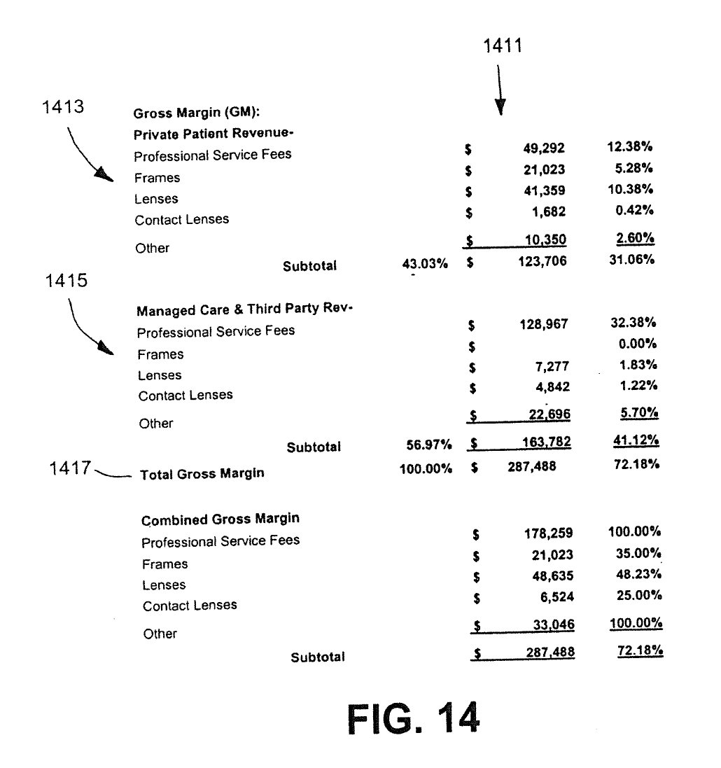

In some embodiments a gross margin for business segments is also calculated. Gross margin sometime provides useful insight into the financial health of a business, and in some businesses may be an important indication of success of the business. FIG. 14 shows a spreadsheet illustrating gross margin for the example of an independent eyecare professional business. Private patient gross margin 1413 is calculated, as is managed care patient gross margin 1415. Gross margin for each category of good 1411 is also determined. The results are summed to provide total gross margin 1417.

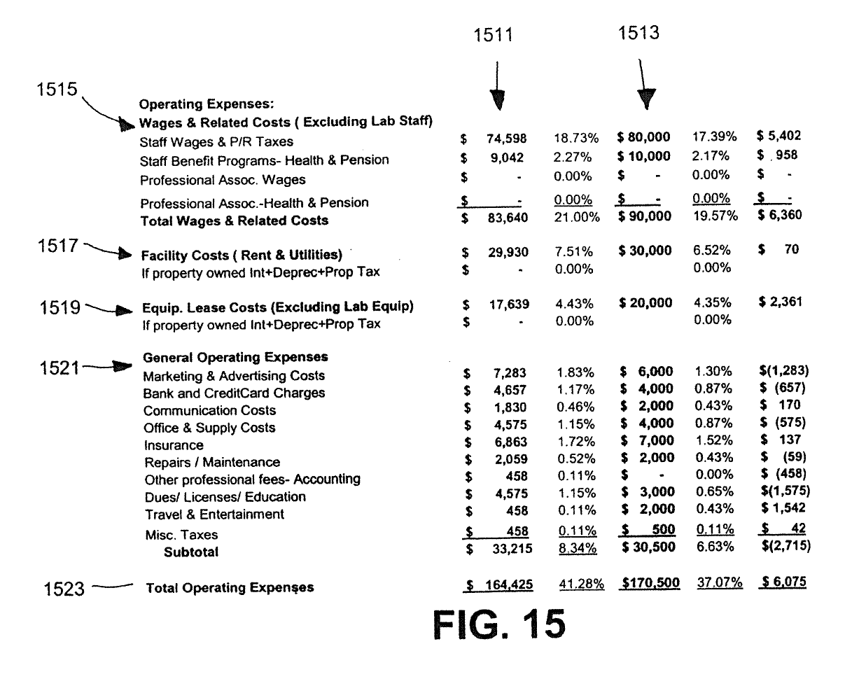

Once again returning to FIG. 9, in block 917 the process computes operating expenses. As with other computations, the process computes operating expenses based on an indication of total amount of business and a percentage of that business in each of two segments. FIG. 15 shows the results of such a computation.

In FIG. 15 operating expenses are shown relating to wages 1515, facility costs 1517, equipment costs 1519, and general operating costs 1521. The totals for each are summed to provide total operating expenses. Operating costs may often be estimated as a percentage of gross revenue. In addition, often operating expenses differ depending on business segment. For example, an independent eyecare professional business may incur increased staff costs with increased number of managed care patients to process paperwork associated with managed care regimes. Similarly, communication costs may also increase with increasing numbers of managed care patients to account for communications with managed care organizations. Conversely, advertising costs and bank charges for credit transactions are likely to increase with increasing numbers of private patients.

Accordingly, the process in block 917 of FIG. 9 determines a weighted blend of operating costs based on percentage of business per segment and estimated percentage costs for line items for each segment. The weighted blend for each line item is multiplied by gross revenue to arrive at operating expenses for each line item 1511. Conveniently, in some embodiments a user is also offered the opportunity to provide actual operating expenses 1513 for a business for benchmark comparison purposes.

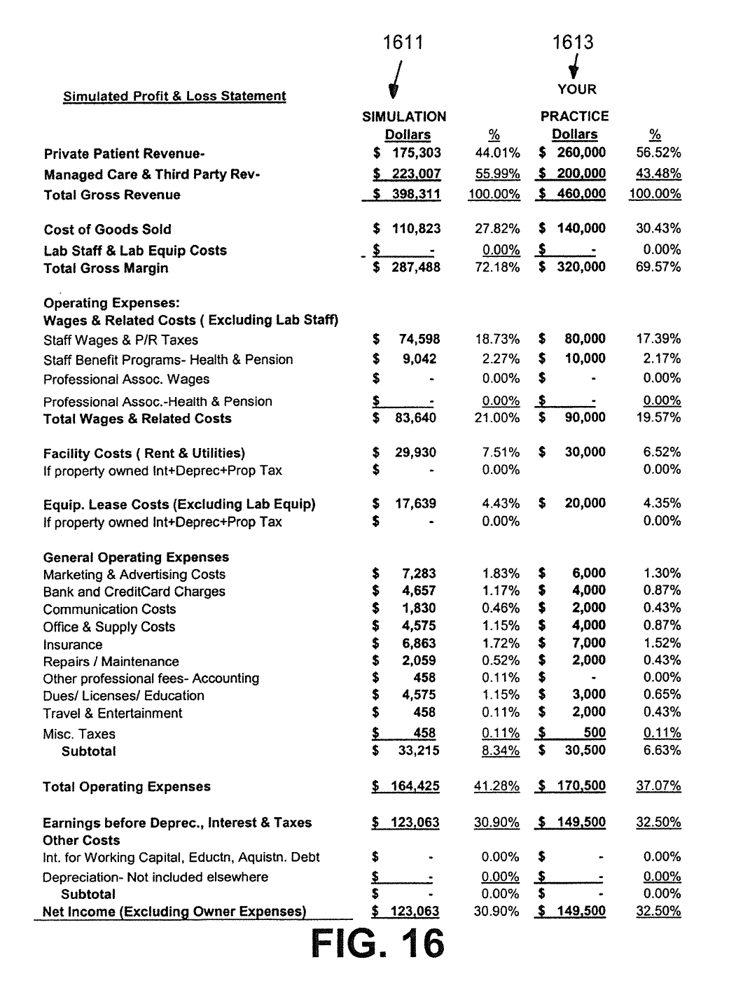

In block 919 of FIG. 9 the process generates a profit and loss statement. An example profit and loss statement for the independent eyecare professional business is shown in FIG. 16. In FIG. 16 details from prior calculations 1611 are organized in the form of a profit and loss statement. In addition, net income is calculated using gross revenue, cost of goods sold, and operating expenses. Again, in some embodiments a user is provided the opportunity to provide information regarding actual results from their own business for comparison purposes.

Accordingly, the invention provides easy to use financial simulations for a business. Although the invention has been described with respect to specific embodiments, it should be recognized that the invention may be practiced other than as specifically discussed, and the invention should be considered the claims and their insubstantial variations supported by this disclosure.

1. A method performed using at least one computer system for generating a profit and loss statement for an eyecare business using a limited set of input parameters, comprising:
receiving values, by the at least one computer system, generated by a user for a limited set of parameters consisting of a total number of patients and a percentage of patients covered by a third party payor plan, the limited set of parameters describing operations of the business, the total number of patients descriptive of a totality of business operations of the eyecare business and the percentage of patients covered by a managed care plan indicative of a split of business operations of the eyecare business into at least two segments; and
determining, by the at least one computer system, financial results of operation of the eyecare business based on the values for the limited set of parameters and a predetermined revenue per patient for managed care patients, a predetermined revenue per patient for non-managed care plan patients, a predetermined cost of goods per patient for managed care patients, a predetermined cost of goods sold per patient for non-managed care patients, and a weighting to gross revenues for line item expenses for managed care patients and a weighting to gross revenues for line item expenses for non-managed care patients, at least some of the relationships between financial figures portraying portions of operations of the business; and
displaying to the user, by the at least one computer system, the determined financial results of operation of the business.

2. The method of claim 1 wherein the values for the limited set of parameters comprise values indicative of actual business operations.

3. The method of claim 1 wherein the values for the limited set of parameters comprise values indicative of simulated business operations.

4.-18. (canceled)
